(19) United States
(12) Patent Application Publication
(10) Pub. No.: US 2021/0362698 A1
(43) Pub. Date: Nov. 25, 2021

(54) BRAKING CONTROL DEVICE

(71) Applicant: ADVICS CO., LTD., Kariya-shi, Aichi-ken (JP)

(72) Inventors: Yasuhito ISHIDA, Toyokawa-shi, Aichi-ken (JP); Kunihiro NISHIWAKI, Toyota-shi, Aichi-ken (JP); Tatsushi KOBAYASHI, Kariya-shi, Aichi-ken (JP); Tomotaka ASANO, Toyota-shi, Aichi-ken (JP); Ken KUZUYA, Kariya-shi, Aichi-ken (JP); Takayuki YAMAMOTO, Nagakute-shi, Aichi-ken (JP)

(73) Assignee: ADVICS CO., LTD., Kariya-shi, Aichi-ken (JP)

(21) Appl. No.: 16/644,004

(22) PCT Filed: Sep. 5, 2018
(86) PCT No.: PCT/JP2018/032789

§ 371 Date: Mar. 3, 2020

(30) Foreign Application Priority Data
Sep. 5, 2017 (JP) 2017-170554
Aug. 31, 2018 (JP) 2018-163237

(51) Int. Cl. B60T 8/94; B60T 17/22; B60T 13/58; B60T 13/66

(52) U.S. Cl. CPC B60T 8/94; B60T 17/221; B60T 13/58; B60T 13/686; B60T 2270/402; B60T 2270/88; B60T 13/662

(57) ABSTRACT

A braking control device includes an upstream mechanism control unit, a determination unit, and a control unit. The upstream mechanism control unit is configured to feedback control the upstream mechanism in such a manner that a detected hydraulic pressure detected by a hydraulic pressure sensor is brought to an upstream target hydraulic pressure. The hydraulic pressure sensor detects a hydraulic pressure of the hydraulic pressure circuit. The determination unit is configured to determine, based on the detected hydraulic pressure by the hydraulic pressure sensor, whether hydraulic pressure hunting is occurring. The control unit is configured to control the downstream mechanism based on the upstream target hydraulic pressure and the target wheel pressure in a case where the determination unit determines that the hydraulic pressure hunting is occurring.

### TECHNICAL FIELD

The present disclosure relates to a braking control device.

### BACKGROUND ART

In general, as a braking control device for vehicles, such as passenger cars, there is known, for example, a braking control device for cooperatively controlling an upstream mechanism and a downstream mechanism based on a target wheel pressure, which is a target value of a hydraulic pressure in wheel cylinders. Here, the upstream mechanism is configured to increase or decrease a hydraulic pressure of a brake fluid in a master cylinder. Also, the downstream mechanism is connected to the upstream mechanism via a hydraulic pressure circuit and is configured to increase or decrease a hydraulic pressure output from the upstream mechanism and then to supply the hydraulic pressure to the wheel cylinders.

In such a brake control device, the upstream mechanism is feedback controlled such that a detected hydraulic pressure of a brake fluid in the upstream mechanism is brought to an upstream target hydraulic pressure, and also the downstream mechanism is feedback controlled such that a detected hydraulic pressure of a brake fluid in the downstream mechanism is brought to a target wheel pressure.

### CITATION LIST

### Patent Literature

PTL 1: Japanese Patent Application Publication No. 2016-2977

### SUMMARY OF INVENTION

### Technical Problem

In the related art as described above, the feedback control is concurrently and independently executed on both the upstream mechanism and the downstream mechanism. As a result, there is a risk that a mutual interference in control occurs. Specifically, an inflow/outflow of the brake fluid is repeated in order to adjust a hydraulic pressure between the upstream mechanism and the downstream mechanism. Thus, there is a case where a hydraulic pressure hunting phenomenon, in which an increase and decrease in hydraulic pressure of the brake fluid are repeated on both the upstream mechanism and the downstream mechanism, occurs.

Accordingly, one of objects to be solved by the present disclosure is to provide a brake control device, in which even if a hydraulic pressure hunting occurs, the hydraulic pressure hunting can be quickly eliminated.

### Solution to Problem

For example, the present disclosure is directed to a braking control device for cooperatively controlling an upstream mechanism and a downstream mechanism based on a target wheel pressure. The target wheel pressure is a target value of a hydraulic pressure in wheel cylinders. The upstream mechanism is configured to increase or decrease a hydraulic pressure of a brake fluid in a master cylinder. The downstream mechanism is connected to the upstream mechanism via a hydraulic pressure circuit and is configured to increase or decrease a hydraulic pressure output from the upstream mechanism and then to supply the hydraulic pressure to the wheel cylinders. The braking control device includes an upstream mechanism control unit, a determination unit, and a control unit. The upstream mechanism control unit is configured to feedback control the upstream mechanism in such a manner that a detected hydraulic pressure detected by a hydraulic pressure sensor is brought to an upstream target hydraulic pressure. The hydraulic pressure sensor detects a hydraulic pressure of the hydraulic pressure circuit. The determination unit is configured to determine, based on the detected hydraulic pressure by the hydraulic pressure sensor, whether or not hydraulic pressure hunting is occurring. The control unit is configured to control the downstream mechanism based on the upstream target hydraulic pressure and the target wheel pressure in a case where the determination unit determines that the hydraulic pressure hunting is occurring. Therefore, when the hydraulic pressure hunting is occurring, the downstream mechanism can be controlled based on the upstream target hydraulic pressure, instead of the detected hydraulic pressure by the hydraulic pressure sensor. As a result, it is possible to remove a mutual interference in control between the upstream mechanism and the downstream mechanism and thus to quickly eliminate the hydraulic pressure hunting.

### BRIEF DESCRIPTION OF DRAWINGS

FIG. 1 is a partially sectional explanatory view showing a configuration of a vehicle braking apparatus according to a first embodiment.

FIG. 2 is a flow chart showing a process in a downstream mechanism control unit according to the first embodiment.

FIG. 3 is a time chart showing an aspect of a sequential change in a hydraulic pressure, a result of determination of a hydraulic pressure hunting and control on a downstream mechanism according to the first embodiment.

FIG. 4 is a flow chart showing a process in a downstream mechanism control unit according to a second embodiment.

FIG. 5 is a time chart showing an aspect of a sequential change in a hydraulic pressure, a result of estimation of occurrence of hydraulic pressure hunting, a result of determination of a difference between an actual M/C pressure and a target M/C pressure, and control on a downstream mechanism according to the second embodiment.

### DESCRIPTION OF EMBODIMENTS

Hereinafter, embodiments (first and second embodiments) of the present disclosure will be described with reference to the accompanying drawings. Meanwhile, configurations of the embodiments described below and the operation and results (effects) obtained by the configurations are merely examples, and accordingly the present disclosure is not limited to the contents described below. In addition, the vehicle braking apparatus is provided on, for example, a four-wheel general vehicle (passenger car). Further, in the following, an electromagnetic valve means a valve capable of electrically switching between an opened state and a closed state.

### First Embodiment

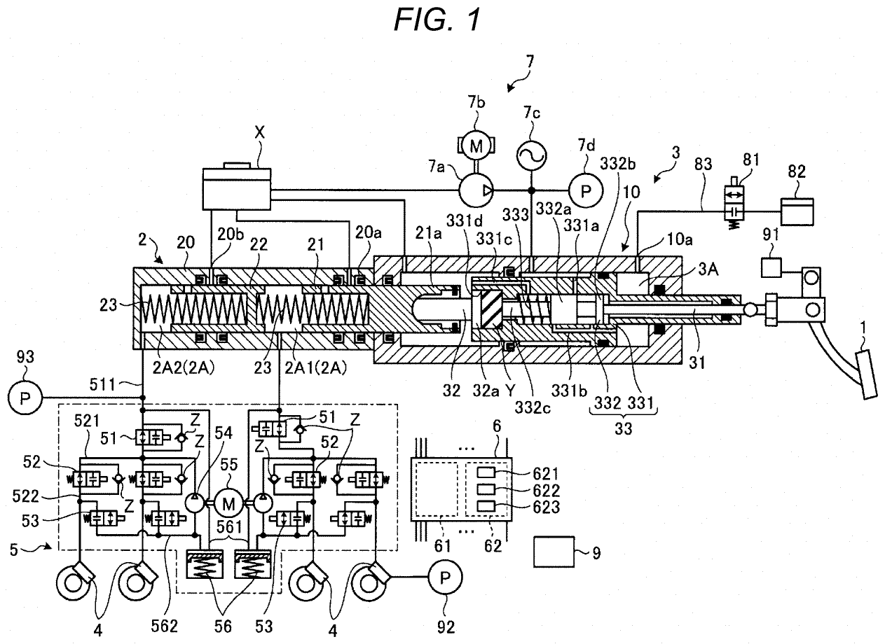

First, a first embodiment will be described. FIG. 1 is a partially sectional explanatory view showing a configuration of a vehicle braking apparatus according to the first embodiment. As shown in FIG. 1, the vehicle braking apparatus according to the first embodiment includes a brake pedal 1, a booster housing 10, a hydraulic pressure generation device 2, a boosting device 3, wheel cylinders 4, a hydraulic pressure control device 5, a brake ECU (Electronic Control Unit) 6, a hydraulic pressure source 7, an electromagnetic valve 81, a reservoir 82, various sensors 91 to 93 communicating with the brake ECU 6, and a hybrid ECU 9.

The hydraulic pressure generation device 2 includes a master cylinder 20, a first master piston 21, a second mater piston 22, a return spring 23, and a reservoir X. Meanwhile, in the following description, a direction (left direction in FIG. 1) , along which the first master piston 21 and the second master piston 22 are driven by depressing the brake pedal 1, is referred to as a “forward movement direction”, and a direction (right direction in FIG. 1) opposite thereto is referred to as a “backward movement direction.” The master housing 20 is connected to a forward-side end portion of the booster housing 10. The master cylinder 20 is similar to a known tandem type master cylinder, and accordingly the detailed description thereof will be omitted.

In the master cylinder 20, a “first master chamber 2A1” is formed (defined) by an inner circumferential surface of the master cylinder 20, a forward-side portion of the first master piston 21 and a backward-side portion of the second master piston 22. Similarly, in the master cylinder 20, a “second master chamber 2A2” is formed (defined) by the inner circumferential surface of the master cylinder 20 and a forward-side portion of the second master piston 22. The hydraulic pressure generation device 2 is configured to generate a hydraulic pressure in the first master chamber 2A1 or the second master chamber 2A2 as the master pistons 21, 22 are slid relative to the master cylinder 20. Hereinafter, the first master chamber 2A1 and the second master chamber 2A2 are referred to as a master chamber 2A.

The master pistons 21, 22 are formed in a shape of a bottomed barrel opened at a forward side thereof and are urged in the backward movement direction by the return spring 23. Herein, the first master piston 21 has a rear end portion 21a extending from a backward-side end portion thereof in the backward movement direction. On the backward-side end portion of the rear end portion 21a, a recess is formed to be recessed in the forward movement direction. The reservoir X is connected ports 20a, 20b of the master cylinder 20. When the master pistons 21, 22 are positioned at an initial position, the reservoir X and the master chamber 2A are communicated with each other.

The hydraulic pressure source 7 includes a pump 7a connected to the reservoir X, a motor 7b for driving the pump 7a, an accumulator 7c and a pressure sensor 7d. The hydraulic pressure source 7 is configured to turn on or off the motor 7b based on a detected pressure by the pressure sensor 7d and thereby to keep a hydraulic pressure, which is accumulated in the accumulator 7c, between predetermined upper and lower limit values.

The boosting device 3 is arranged in the booster housing 10 and has an input rod 31, an output member 32 and a pressure adjustment portion 33. The boosting device 3 is a device for supplying a hydraulic pressure from the hydraulic pressure source 7 into an assist chamber 3A in accordance with operation on the brake pedal 1. Meanwhile, a configuration including the booster housing 10 and the hydraulic pressure source 7 may be referred to as the boosting device 3.

The input rod 31 is connected to the brake pedal 1 at a backward-side end thereof and is configured to move forward or backward in accordance with an operation amount (operation force) on the brake pedal 1. The output member 32 is arranged at a forward-side end portion of a reaction force application member Y as described below and is configured to move forward in accordance with a forward movement of a boost piston 331 as described below.

The pressure adjustment portion 33 includes the boost piston 331 and a spool valve 332 . The boost piston 331 is formed in a generally cylindrical shape, and the input rod 31, the spool valve 332 and the reaction force application member Y are received therein. The boost piston 331 defines the assist chamber 3A on a backward side in the booster housing 10. That is, on the backward side of the boost piston 331, the assist chamber 3A is formed (defined) by the boost piston 331 and an inner circumferential surface of the booster housing 10.

The boost piston 331 is provided with passages 331a, 331b, 331c. The passage 331a is a passage for communicating the hydraulic pressure source 7 with the inside of the boost piston 331. The passage 331b is a passage for communicating the assist chamber 3A with the inside of the boost piston 331 . The passage 331c is a passage for communicating the reservoir X with the inside of the boost piston 331.

The spool valve 332 has large diameter portions 332a, 332b having a diameter larger than that of the input rod 31 and is configured to open or close each of the passages 331a to 331c by sliding a position of the large diameter portions 332a, 332b relative to the boost piston 331 forward or backward. The spool valve 332 is connected to the input rod 31 and thus is configured to slide in accordance with forward and backward movement of the input rod 31. The boost piston 331 has a bottomed large diameter hole 331d formed to be opened at a forward-side end surface thereof, and the reaction force application member Y is arranged in the large diameter hole 331d. A small diameter portion 332c formed on the forward-side end portion of the spool valve 332 slidably extends through the bottom of the large diameter hole 331d and then abuts against the reaction force application member Y.

As the brake pedal 1 is depressed so that the input rod 31 moves forward relative to the boost piston 331 and thus the large diameter portion 332a moves forward by a predetermined amount, the passage 331a in the pressure adjustment portion 33 is opened and thus the hydraulic pressure source 7 and the assist chamber 3A are communicated with each other. As a result, a high pressure brake fluid is flowed into the assist chamber 3A. The pressure adjustment portion 33 supplies a high hydraulic pressure into the assist chamber 3A in accordance with operation on the brake pedal 1. If the pressure in the assist chamber 3A becomes high, the boost piston 331 moves forward, thereby moving the output member 32 forward.

The output member 32 is connected to the first master piston 21 at a forward side thereof. A forward-side end portion of the output member 32 is arranged in the recess of the rear end portion 21a. A large diameter portion 32a formed on a backward side of the output member 32 is slidably fitted in the large diameter hole 331d opened on the forward-side end surface of the boost piston 331 and thus abuts against the reaction force application member Y. Meanwhile, in a state where the input rod 31 and the spool valve 332 are returned to the most backward positions thereof by a return spring 333, the passages 331b, 331c are opened and thus the assist chamber 3A and the reservoir X are communicated with each other. The reaction force application member Y is a well-known member (e.g., a reaction disk) formed by a rubber disk and is configured to create a reaction force corresponding to a brake operation amount.

The hydraulic pressure control device 5 includes a valve device 51, a pressure increasing valve 52, a pressure decreasing valve 53, a pump 54, a motor 55 and a reservoir 56. The valve device 51 is a normally open type electromagnetic valve and is connected to a conduit 511 connected to the master chamber 2A. The valve device 51 is an electromagnetic valve capable of controlling between a communication state (not-energized state) and a differential pressure state and is configured such that a differential pressure state between a wheel pressure and a master pressure is varied in accordance with a value of current flowing through a solenoid thereof in a driven state of the pump 54. The larger the current value is, the larger the differential pressure amount becomes. In this way, the valve device 51 is a valve for controlling a brake fluid flow between the hydraulic pressure generation device 2 and the wheel cylinders 4.

The pressure increasing valve 52 is a normally open type electromagnetic valve connected to the valve device 51 and the pump 54 via a conduit 521 on an upstream side (master chamber 2A side) thereof and also connected to the wheel cylinders 4 via a conduit 522 on a downstream side (wheel cylinder 4 side) thereof. That is, a brake fluid from the master chamber 2A is supplied to the wheel cylinders 4 via the valve device 51 and the pressure increasing valve 52. The pressure increasing valve 52 is a 2-position valve capable of controlling between a communication state and an interruption state. The pressure increasing valve 52 becomes the communication state during a normal brake operation. Also, each of the pressure increasing valve 52 and the valve device 51 is provided with a safety valve Z in parallel.

The pressure decreasing valve 53 is a normally closed type electromagnetic valve connected to the conduit 522 on one side thereof and connected to the reservoir 56 and the pump 54 on the other side thereof. The pressure decreasing valve 53 is a 2-position valve capable of controlling between a communication state and an interruption state. The pressure decreasing valve 53 becomes the interruption state during a normal brake operation.

The pump 54 is a pump connected to the reservoir 56 and the pressure decreasing valve 53 on a suction side thereof and connected to the conduit 521 (downstream of the valve device 51 and also upstream of the pressure increasing valve 52) on an ejection side thereof. The pump 54 is driven by the motor 55. The motor 55 is controlled to turn on or off by the brake ECU 6. That is, the brake ECU 6 drives the motor 55, thereby activating the pump 54. The pump 54 is configured to eject a brake fluid on the hydraulic pressure generation device 2 side of the valve device 51 to the wheel cylinder 4 side of the valve device 51. The reservoir 56 is connected to the master chamber 2A via a conduit 561 and also connected to the pump 54 and the pressure decreasing valve 53 via a conduit 562.

Control of the hydraulic pressure control device 5 may be executed by a known method. In brief, the hydraulic pressure control device 5 controls a brake fluid flow between the master cylinder 20 and the wheel cylinders 4 by means of the valve device 51 and then ejects a brake fluid on the master cylinder 20 side of the valve device 51 to the wheel cylinder 4 side of the valve device 51 by means of the pump 54, thereby controlling the wheel pressure to become higher than a master pressure. Also, the hydraulic pressure control device 5 opens a brake fluid flow between the master cylinder 20 and the wheel cylinders 4 by means of the valve device 51, thereby controlling the wheel pressure to become substantially the same as the master pressure.

For a hybrid vehicle, a braking force is the sum of a hydraulic braking force, which is obtained by adding a control hydraulic pressure to a master pressure, and a regenerative braking force, which is obtained by a regenerative brake of a motor. Therefore, if the brake pedal 1 is operated, the brake ECU 6 calculates a target braking force (total required braking force) corresponding to the brake operation amount, calculates a control braking force obtained by subtracting a base braking force and a regenerative braking force, which is received from the hybrid ECU 9, from the target braking force, and then controls the hydraulic pressure control device 5 to generate a control hydraulic pressure corresponding to the control braking force.

For example, if the brake pedal 1 is depressed, a base braking force based on the master pressure and a regenerative braking force are generated. Then, if the base braking force and the regenerative braking force alone are not enough for the target braking force, the hydraulic pressure control device 5 generates a control hydraulic pressure by throttling a flow path by means of the valve device 51 and also ejecting a brake fluid by means of the pump 54. At this time, in order to maintain the target braking force (deceleration) corresponding to the brake operation amount (stroke), the wheel pressure is controlled in accordance with increase or decrease in the regenerative braking force. The brake ECU 6 controls the wheel pressure by controlling throttling of the valve device 51.

The electromagnetic valve 81 is a normally closed type linear valve provided on a conduit 83 connecting a port 10a provided in a wall portion of the booster housing 10, which defines the assist chamber 3A, with the reservoir 82. In other words, the electromagnetic valve 81 is a linear valve arranged in a flow path connecting the assist chamber 3A with the reservoir 82 to communicate or interrupt between the assist chamber 3A and the reservoir 82. Opening and closing of the electromagnetic valve 81 is controlled by the brake ECU 6. Alternatively, the reservoir 82 may be replaced by the reservoir X. Also, although the electromagnetic valve 81 is a linear valve, of which an opening degree can be adjusted, it is sufficient if a valve device, of which opening and closing can be controlled, is employed.

A stroke sensor 91 sends an operation amount (stroke information) on the brake pedal 1 to the brake ECU 6. Pressure sensors 92 provided on the wheel cylinders 4 sends a wheel pressure information to the brake ECU 6. A pressure sensor (hydraulic pressure sensor) provided on the conduit 511 sends a master pressure information to the brake ECU 6. The hybrid ECU 9 sends a regenerative braking force information to the brake ECU 6.

Hereinafter, various mechanisms for increasing or decreasing a hydraulic pressure of a brake fluid in the master cylinder 20 is referred to as an upstream mechanism. Also, various mechanisms connected to the upstream mechanism via a hydraulic pressure circuit (conduit 511 and the like) and configured to increase or decrease a hydraulic pressure output from the upstream mechanism and then to supply the hydraulic pressure to the wheel cylinders 4 are referred to as a downstream mechanism.

The brake ECU 6 is a braking control device for cooperatively controlling the upstream mechanism and the downstream mechanism based on a target wheel pressure, which is a target value of a hydraulic pressure in the wheel cylinders 4. The brake ECU 6 has hardware, such as a processor and a memory, similar to those of a typical computer. The brake ECU 6 and the hybrid ECU 9 are configured to send or receive information by a CAN (Controller Area Network) communication.

The brake ECU 6 has an upstream mechanism control unit 61 and a downstream mechanism control unit 62. In FIG. 1, the upstream mechanism control unit 61 and the downstream mechanism control unit 62 are physically realized in a single brake ECU 6. Alternatively, the upstream mechanism control unit 61 and the downstream mechanism control unit 62 may be physically realized as separate ECUs. In this case, the upstream mechanism control unit 61 and the downstream mechanism control unit 62 are configured to send or receive information by the CAN communication.

The upstream mechanism control unit 61 is configured to feedback-control (hereinafter, referred to as FB control) the upstream mechanism in such a manner that a detected hydraulic pressure detected by the pressure sensor 93 (hydraulic pressure sensor) for detecting a hydraulic pressure in the hydraulic pressure circuit is brought to an upstream target hydraulic pressure calculated in accordance with an operation amount on the brake pedal 1.

The downstream mechanism control unit 62 is configured to control the downstream mechanism in such a manner that a detected hydraulic pressure of the wheel cylinders 4 detected by the pressure sensor 92 is brought to a target wheel pressure calculated in accordance with an operation amount on the brake pedal 1. The downstream mechanism control unit 62 includes an acquisition unit 621, a determination unit 622 and a control unit 623 as functional components thereof.

The acquisition unit 621 is configured to acquire a detected hydraulic pressure detected by the pressure sensor 93 and a detected hydraulic pressure detected by the pressure sensor 92.

The determination unit 622 is configured to determine whether or not a hydraulic pressure hunting is occurring based on the detected hydraulic pressure by the pressure sensor 93 (hydraulic pressure sensor). For example, in a case where an increase or decrease in the detected hydraulic pressure by the pressure sensor 93 (hydraulic pressure sensor) occurs the number of times equal to or more than a predetermined value within a predetermined period of time, the determination unit 622 determines that a hydraulic pressure hunting is occurring.

When the determination unit 622 determines that a hydraulic pressure hunting is not occurring, the control unit 623 FB-controls the downstream mechanism based on the detected hydraulic pressure by the pressure sensor 93 (hydraulic pressure sensor), the detected hydraulic pressure by the pressure sensor 92 and the target wheel pressure in such a manner that the detected hydraulic pressure by the pressure sensor 92 is brought to the target wheel pressure.

Also, when the determination unit 622 determines that a hydraulic pressure hunting is occurring, the control unit 623 feedforward controls (hereinafter, referred to as FF-control) the downstream mechanism, based on the upstream target hydraulic pressure, the detected hydraulic pressure by the pressure sensor 92 and the target wheel pressure.

Therefore, until the determination unit 622 determines that a hydraulic pressure hunting is occurring, both the upstream mechanism control unit 61 and the downstream mechanism control unit 61 execute FB-control concurrently and independently. As a result, there is a risk that a mutual interference in control occurs. That is, an inflow/outflow of the brake fluid is repeated in order to adjust a hydraulic pressure between the upstream mechanism and the downstream mechanism. Thus, there is a case where a hydraulic pressure hunting, in which an increase and decrease in hydraulic pressure of the brake fluid are repeated on both the upstream mechanism and the downstream mechanism, occurs. More specifically, for example, there is a case where an operation, in which the upstream mechanism ejects a brake fluid into the downstream mechanism for hydraulic pressure adjustment and then the downstream mechanism, of which a hydraulic pressure is changed by receiving the brake fluid, ejects the brake fluid into the upstream mechanism for hydraulic pressure adjustment, is repeated many times.

Therefore, according to the first embodiment, when a hydraulic pressure hunting has occurred, control on the downstream mechanism is switched from the FB-control based on the detected hydraulic pressure by the pressure sensor 93 to the FF-control based on the upstream target hydraulic pressure, thereby removing a mutual interference in control between the upstream mechanism and the downstream mechanism and thus quickly eliminating the hydraulic pressure hunting.

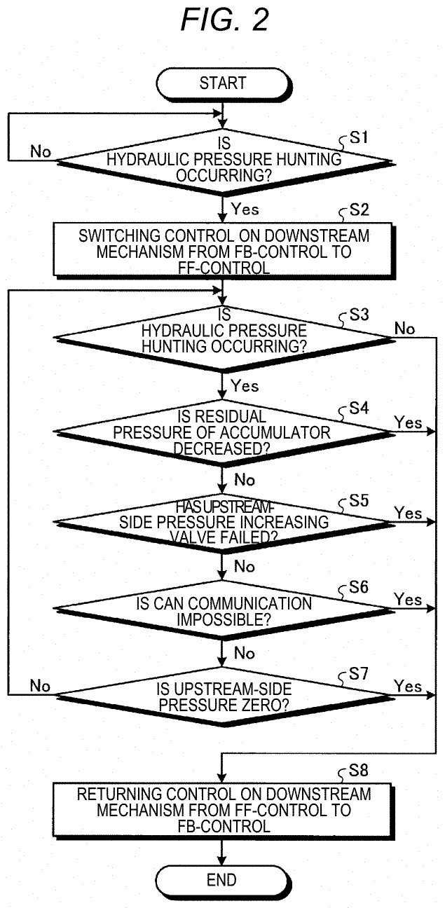

Next, a process in the downstream mechanism control unit 62 according to the first embodiment will be described with reference to FIG. 2. FIG. 2 is a flow chart showing a process in the downstream mechanism control unit 62 according to the first embodiment. Herein, it is assumed that the brake pedal 1 has been depressed at least upon start of the flow chart. Also, it is assumed that the acquisition unit 621 of the downstream mechanism control unit 62 in the brake ECU 6 is frequently acquiring a detected hydraulic pressure detected by the pressure sensor 93 and a detected hydraulic pressure detected by the pressure sensor 92. Further, it is assumed that upon start of the flow chart, both the upstream mechanism control unit 61 and the downstream mechanism control unit 62 are executing the above FB-control concurrently and independently.

At a step S1, the determination unit 622 determines whether or not a hydraulic pressure hunting is occurring based on the detected hydraulic pressure by the pressure sensor 93 acquired by the acquisition unit 621. If Yes, the process proceeds to a step S2, whereas if No, the process returns to the step S1.

At the step S2, the control part 623 switches control on the downstream mechanism from the FB-control to the FF-control.

Then, at a step S3, the determination unit 622 determines whether or not a hydraulic pressure hunting is occurring based on the detected hydraulic pressure by the pressure sensor 93 acquired by the acquisition unit 621. If Yes, the process proceeds to a step S4, whereas if No, the process proceeds to a step S8.

At the step S8, the control unit 623 returns control on the downstream mechanism from the FF-control to the FB-control, and then the process is ended.

At the step S4, the control unit 623 determines whether or not a residual pressure of the accumulator 7c is lower than a predetermined value. If Yes, the process proceeds to the step S8, whereas if No, the process proceeds to a step S5. Meanwhile, the reason why, if the residual pressure of the accumulator 7c is lower than the predetermined value (Yes at the step S4), the process proceeds to the step S8 to return control on the downstream mechanism from the FF-control based on the upstream target hydraulic pressure to the FB-control based on the detected hydraulic pressure by the pressure sensor 93 is because reliability of the upstream target hydraulic pressure has been reduced.

At the step S5, the control unit 623 determines whether or not an upstream-side pressure increasing valve (pressure increasing valve, not shown, in the upstream mechanism) has failed. If Yes, the process proceeds to the step S8, whereas if No, the process proceeds to a step S6. Meanwhile, the reason why, if the upstream-side pressure increasing valve has failed (Yes at the step S5) , the process proceeds to the step S8 to return control on the downstream mechanism from the FF-control based on the upstream target hydraulic pressure to the FB-control based on the detected hydraulic pressure by the pressure sensor 93 is because reliability of the upstream target hydraulic pressure has been reduced.

The step S6 is based on the assumption that the upstream mechanism control unit 61 and the downstream mechanism control unit 62 are physically realized as separate ECUs to send and receive information by the CAN communication and thus the downstream mechanism control unit 62 frequently receives the upstream target hydraulic pressure from the upstream mechanism control unit 61. At the step S6, the control unit 623 determines whether or not the CAN communication is impossible. If Yes, the process proceeds to the step S8, whereas if No, the process proceeds to a step S7. Meanwhile, the reason why, if the CAN communication is impossible (Yes at the step S6) , the process proceeds to the step S8 to return control on the downstream mechanism from the FF-control based on the upstream target hydraulic pressure to the FB-control based on the detected hydraulic pressure by the pressure sensor 93 is for the purpose of avoiding instability of control, which will be caused because the downstream mechanism control unit 62 cannot receive the upstream target hydraulic pressure from the upstream mechanism control unit 61.

At the step S7, the control unit 623 determines whether or not an upstream-side pressure (the detected hydraulic pressure by the pressure sensor 93) is zero. If Yes, the process proceeds to the step S8, whereas if No, the process proceeds to the step S3. Meanwhile, the reason why, if the upstream-side pressure is zero (Yes at the step S7) , the process proceeds to the step S8 to return control on the downstream mechanism from the FF-control based on the upstream target hydraulic pressure to the FB-control based on the detected hydraulic pressure by the pressure sensor 93 is for the purpose of avoiding instability of control, which will be caused by executing the FF-control based on the upstream target hydraulic pressure when the upstream-side pressure is zero.

Meanwhile, among the steps S3 to S7, the essential processing is only the step S3 and the steps S4 to S7 are optional processing.

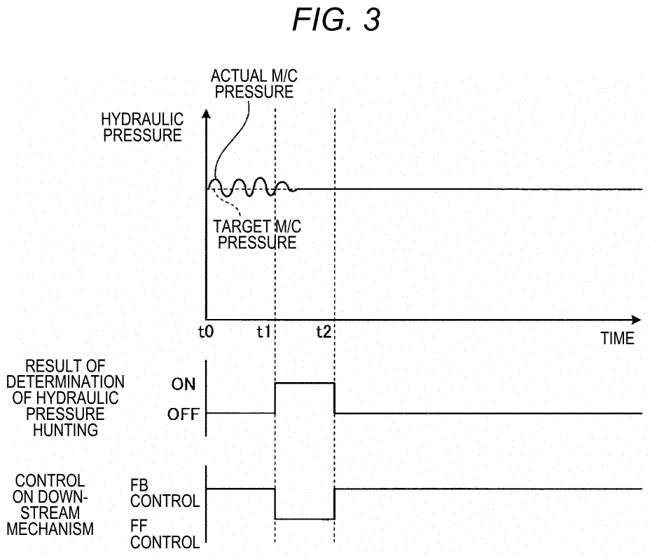

Next, a sequential change in a hydraulic pressure, a result of determination of a hydraulic pressure hunting and control on the downstream mechanism according to the first embodiment will be described with reference to FIG. 3. FIG. 3 is a time chart showing an aspect of a sequential change in a hydraulic pressure, a result of determination of a hydraulic pressure hunting and control on a downstream mechanism according to the first embodiment. Meanwhile, it should be noted that a target M/C pressure (upstream target hydraulic pressure) is not always constant (invariant over time), but is assumed to be constant herein for simplicity of description and illustration.

In FIG. 3, an actual M/C pressure (a detected hydraulic pressure by the pressure sensor 93) is repeatedly increased and decreased during a time t0 to a time t1. Accordingly, it is assumed that at the time t1, the determination unit 622 determines that a hydraulic pressure hunting is occurring (from OFF to ON).

Then, the control unit 623 switches control on the downstream mechanism from the FB-control based on the detected hydraulic pressure by the pressure sensor 93 to the FF-control based on the upstream target hydraulic pressure. As a result, the increase and decrease in the actual M/C pressure is suppressed, and thus at a time t2, the determination unit 622 determines that a hydraulic pressure hunting is not occurring (from ON to OFF).

Then, the control unit 623 returns control on the downstream mechanism from the FF-control based on the upstream target hydraulic pressure to the FB-control based on the detected hydraulic pressure by the pressure sensor 93. Since at the time t2, the hydraulic pressure hunting has been suppressed, there is a lower possibility that after the time t2, the hydraulic pressure hunting immediately reoccurs even if control on the downstream mechanism is returned to the FB-control.

In this way, according to the braking control device (brake ECU 6) of the first embodiment, the downstream mechanism can be controlled based on the upstream target hydraulic pressure, instead of the detected hydraulic pressure by the pressure sensor 93, when the hydraulic pressure hunting is occurring, thereby removing a mutual interference in control between the upstream mechanism and the downstream mechanism and thus quickly eliminating the hydraulic pressure hunting. Therefore, it is possible to inhibit deterioration of brake feeling or instability of control due to the hydraulic pressure hunting.

Also, when an increase or decrease in the detected hydraulic pressure by the pressure sensor 93 occurs the number of times equal to or more than a predetermined value within a predetermined period of time, it is determined that a hydraulic pressure hunting is occurring, thereby ensuring that occurrence of the hydraulic pressure hunting can be accurately determined.

In addition, when the hydraulic pressure hunting is not occurring, the downstream mechanism can be FB-controlled based on the detected hydraulic pressure by the pressure sensor 93. Therefore, it is possible to make the detected hydraulic pressure by the pressure sensor 92 more quickly approximate the target wheel pressure.

### Second Embodiment

Next, a second embodiment will be described. The overlapping description with respect to configurations similar to those of the first embodiment will be properly omitted. Meanwhile, control by the brake ECU 6 according to the second embodiment is generally applied when pressurization is performed by the upstream mechanism, and may be applied upon any of stopping, traveling (slowly depressing) or traveling (quickly depressing).

In the first embodiment, a condition for switching control on the downstream mechanism from the FB-control to the FF-control is that it is determined that a hydraulic pressure hunting is occurring based on the detected hydraulic pressure by the pressure sensor 93 (hydraulic pressure sensor). Instead, the above condition may be changed to a condition that occurrence of a hydraulic pressure hunting is estimated. The case where occurrence of a hydraulic pressure hunting is estimated is, in other words, a case where a condition, under which it is considered that a probability of occurrence of a hydraulic pressure hunting is high, is satisfied. For example, the case may include a case where an upstream-side pressure (a detected hydraulic pressure by the pressure sensor 93) occurs and also a hydraulic pressure in the downstream mechanism is maintained, a case where a revolution number of the motor 55 of the downstream mechanism is equal to or larger than a predetermined revolution number or the like. By changing the above condition in this way, switching can be quickly performed as compared with the case where the switching is performed after an actual occurrence of a hydraulic pressure hunting is determined, thereby further reducing influence due to the hydraulic pressure hunting.

However, in general, there is a time lag between an increase in the target M/C pressure and an increase in the actual M/C pressure. For example, if the control is switched from the FB-control using the actual M/C pressure to the FF-control using the target M/C pressure when the target M/C pressure is significantly higher than the actual M/C pressure, such as upon start of hydraulic pressure adjustment by the upstream mechanism, there is a case where an increase in the wheel pressure is delayed and hence the braking effect is also delayed. Therefore, the second embodiment will describe a technique for inhibiting the braking effect from being delayed as described above by changing the above condition to the condition that occurrence of a hydraulic pressure hunting is estimated.

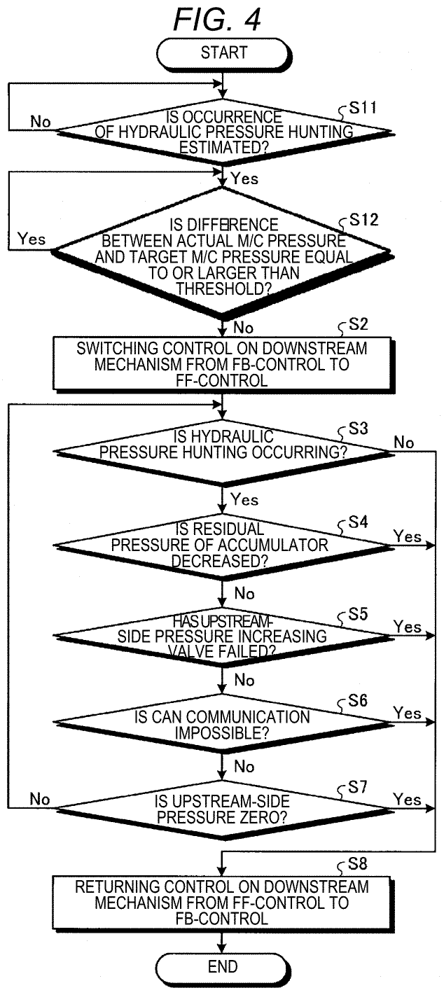

Next, a process in the downstream mechanism control unit according to the second embodiment will be described with reference to FIG. 4. FIG. 4 is a flow chart showing the process in the downstream mechanism control unit according to the second embodiment. The assumption is similar to those in FIG. 2.

At a step S11, the determination unit 622 determines whether or not occurrence of a hydraulic pressure hunting is estimated. If Yes, the process proceeds to a step S12, whereas if No, the process returns to the step S11. The detailed method for estimation is as described above.

At the step S12, the determination unit 622 determines whether a difference (response delay) between the actual M/C pressure and the target M/C pressure is equal to or larger than a predetermined threshold (a previously determined value equal to or larger than 0, i.e., a predetermined allowable value). If Yes, the process proceeds to a step S2, whereas if No, the process returns to the step S12. The steps S2 to S8 are similar to those in FIG. 2.

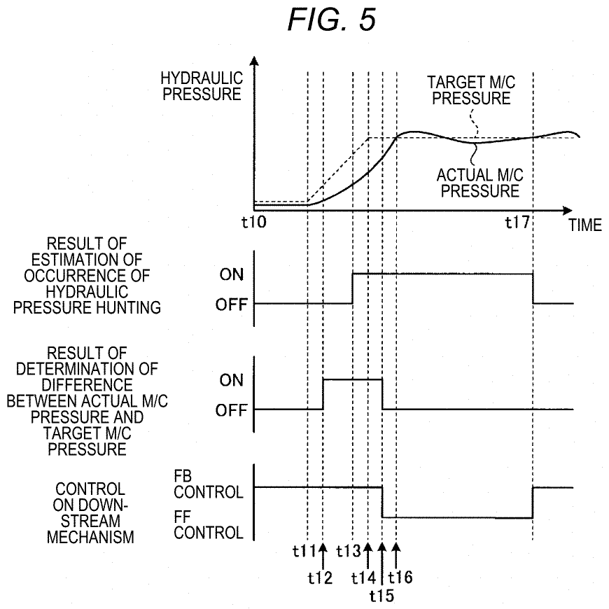

Next, a sequential change in a hydraulic pressure, a result of estimation of occurrence of a hydraulic pressure hunting, a result of determination of a difference between an actual M/C pressure and a target M/C pressure, and control on a downstream mechanism according to the second embodiment will be described with reference to FIG. 5. FIG. 5 is a time chart showing an aspect of a sequential change in a hydraulic pressure, a result of estimation of occurrence of a hydraulic pressure hunting, a result of determination of a difference between an actual M/C pressure and a target M/C pressure, and control on a downstream mechanism according to the second embodiment.

In FIG. 5, after a time t10, the target M/C pressure increases during a time t11 to a time t14 and is constant after the time t14. In this case, the actual M/C pressure follows the target M/C pressure, but during the time t11 to the time 16, the actual M/C pressure is smaller than the target M/C pressure.

Also, it is assumed that the result of estimation of occurrence of a hydraulic pressure hunting by the determination unit 622 is OFF (estimated as non-occurrence) during the time t10 to the time t13, ON (estimated as occurrence) during the time t13 to a time t17, and then OFF after the time t17.

Further, it is assumed that the result of determination of a difference between the actual M/C pressure and the target M/C pressure by the determination unit 622 is OFF (there is no significant difference) during the time t10 to the time t12, ON (there is a significant difference) during the time t12 to the time t15 and then ON after the time t15.

Then, in the process of FIG. 4, a timing when the processing at the step S11 is determined as Yes is the time t13, but a timing when the processing at the step S12 is determined as Yes is the time t15. Accordingly, at the time t15, the control is switched from the FB-control using the actual M/C pressure to the FF-control using the target M/C pressure. That is, the control on the downstream mechanism is the FB-control during the time t10 to the time t15, the FF-control during the time t15 to the time t17, and then the FB-control after the time t17.

Thus, according to the braking control device (brake ECU 6) of the second embodiment, the control is maintained as the FB-control if the target M/C pressure is significantly higher than the actual M/C pressure even when occurrence of a hydraulic pressure hunting is estimated, and then is switched to the FF-control after the actual M/C pressure approximates the target M/C pressure in some degree (a after significant difference is removed). Therefore, it is possible to quickly suppress occurrence of a hydraulic pressure hunting and thus to inhibit the braking effect from being delayed.

Although the embodiments of the present disclosure have been described above, the embodiments are presented only by way of example and are not intended to limit the scope of the disclosure. The foregoing novel embodiments can be implemented in various other modes, and also various omissions, substitutions and changes therein can be made without departing from the spirit and scope of the disclosure. The foregoing embodiments and modifications thereof are encompassed in the spirit and scope of the disclosure and are also encompassed in the disclosure described in the claims and the equivalent scope thereof.

For example, although in the foregoing embodiments, the control on the downstream mechanism is switched from the FB-control based on the detected hydraulic pressure by the pressure sensor 93 to the FF-control based on the upstream target hydraulic pressure when a hydraulic pressure hunting occurs (including estimation thereof), the present disclosure is not limited thereto. For, instead of the FF-control based on the upstream target hydraulic pressure, a control based on a smaller value of the upstream target hydraulic pressure and the detected hydraulic pressure by the pressure sensor 93 or a control based on an average value of the upstream target hydraulic pressure and the detected hydraulic pressure by the pressure sensor 93 maybe employed. By doing so, it is possible to reduce a probability of occurrence of a delay in increasing the pressure, which will be caused because an actual pressure (the detected hydraulic pressure by the pressure sensor 93) is not used at all.

1. A braking control device for cooperatively controlling an upstream mechanism and a downstream mechanism based on a target wheel pressure, the target wheel pressure being a target value of a hydraulic pressure in wheel cylinders, the upstream mechanism being configured to increase or decrease a hydraulic pressure of a brake fluid in a master cylinder, and the downstream mechanism being connected to the upstream mechanism via a hydraulic pressure circuit and being configured to increase or decrease a hydraulic pressure output from the upstream mechanism and then to supply the hydraulic pressure to the wheel cylinders, the braking control device comprising:
an upstream mechanism control unit that is configured to feedback control the upstream mechanism in such a manner that a detected hydraulic pressure detected by a hydraulic pressure sensor is brought to an upstream target hydraulic pressure, the hydraulic pressure sensor being detect a hydraulic pressure of the hydraulic pressure circuit;
a determination unit that is configured to determine, based on the detected hydraulic pressure by the hydraulic pressure sensor, whether or not a hydraulic pressure hunting is occurring; and
a control unit that is configured to control the downstream mechanism based on the upstream target hydraulic pressure and the target wheel pressure in a case where the determination unit determines that the hydraulic pressure hunting is occurring.

2. The braking control device according to claim 1, wherein the determination unit is configured to determine that that hydraulic pressure hunting is occurring in a case where an increase or decrease in the detected hydraulic pressure by the hydraulic pressure sensor occurs the number of times equal to or more than a predetermined value within a predetermined period of time.

3. The braking control device according to claim 1, wherein the control unit is configured to feedback control the downstream mechanism based on the detected hydraulic pressure by the hydraulic pressure sensor and the target wheel pressure in a case where the determination unit determines that the hydraulic pressure hunting is not occurring.

4. The braking control device according to claim 1, wherein the control unit is configured to feedback control the downstream mechanism based on the detected hydraulic pressure by the hydraulic pressure sensor and the target wheel pressure if a response delay of the detected hydraulic pressure by the hydraulic pressure sensor with respect to the upstream target hydraulic pressure is equal to or larger than a predetermined allowable value even when the determination unit determines that the hydraulic pressure hunting is occurring.

5. The braking control device according to claim 2, wherein the control unit is configured to feedback control the downstream mechanism based on the detected hydraulic pressure by the hydraulic pressure sensor and the target wheel pressure in a case where the determination unit determines that the hydraulic pressure hunting is not occurring.

6. The braking control device according to claim 2, wherein the control unit is configured to feedback control the downstream mechanism based on the detected hydraulic pressure by the hydraulic pressure sensor and the target wheel pressure if a response delay of the detected hydraulic pressure by the hydraulic pressure sensor with respect to the upstream target hydraulic pressure is equal to or larger than a predetermined allowable value even when the determination unit determines that the hydraulic pressure hunting is occurring.

7. The braking control device according to claim 3, wherein the control unit is configured to feedback control the downstream mechanism based on the detected hydraulic pressure by the hydraulic pressure sensor and the target wheel pressure if a response delay of the detected hydraulic pressure by the hydraulic pressure sensor with respect to the upstream target hydraulic pressure is equal to or larger than a predetermined allowable value even when the determination unit determines that the hydraulic pressure hunting is occurring.
